(19) United States
(12) Patent Application Publication
(10) Pub. No.: US 2024/0017886 A1
(43) Pub. Date: Jan. 18, 2024

(54) BAG, METHOD AND DEVICE FOR PRODUCING A BAG

(71) Applicant: Windmöller & Hölscher KG, Lengerich (DE)

(72) Inventors: Jörg Christian THIES, Lengerich (DE); Frank SANDER, Lengerich (DE)

(73) Assignee: Windmöller & Hölscher KG, Lengerich (DE)

(21) Appl. No.: 18/254,281

(22) PCT Filed: Nov. 25, 2021
(86) PCT No.: PCT/EP2021/083030

§ 371 Date: May 24, 2023

(30) Foreign Application Priority Data
Nov. 27, 2020 (DE) 10 2020 214 985.2
Apr. 30, 2021 (DE) 10 2021 204 369.0

(51) Int. Cl. B65D 27/38; B31B 70/62; B31B 70/81; B65D 30/20; B65D 33/18; B65D 33/08; B65D 33/02

(52) U.S. Cl. CPC B65D 27/38; B31B 70/628; B31B 70/8123; B65D 31/10; B65D 33/18; B65D 33/08; B65D 33/02; B31B 70/874

(57) ABSTRACT

The invention describes a pouch-type bag, with a first wall and with a second wall, which comprise paper and which are connected to one another via side edges, so that a filling space is provided, wherein the second wall, viewed in the longitudinal direction of the pouch, protrudes beyond the first wall, with two ends, wherein a base is arranged at one end, which base comprises at least one envelope area of the second wall, wherein the envelope area is folded over about a first crease line at least onto parts of the first wall, wherein an opening is provided at the other end, via which opening the filling space is accessible, wherein one of the walls comprises a sealing area which can be folded over about a second crease line onto the outside of the other wall and can be fastened there by means of an adhesive element applied to the sealing area.

The sealing area comprises a tear-off aid between the second crease line and the adhesive element, with which the sealing area can be at least partially severed to allow renewed access to the filling space.

The invention relates to a pouch-type bag according to the preamble of claim 1 as well as a method and a device for producing bags.

Pouch-type bags, especially paper bags, have been known for decades and are widely used on a daily basis. A known pouch-type bag
with a first wall and a second wall, which are connected to each other via side edges so as to provide a filling space, and
with two ends, wherein a base is arranged at one end and an opening is provided at the other end, via which the filling space is accessible, wherein the base comprises at least one envelope area of the second wall, wherein the envelope area is folded over around a crease line at least on parts of the first wall, represents the starting point of the present invention.

The pouch-type bags described above are suitable for a wide range of applications. For example, end users can fill goods purchased in retail stores into such pouch-type bags and transport them. For transporting baked goods, for example, the opening can be closed after the goods have been placed in the bag by folding it over and/or rolling it up once or several times. The folded-over end that was previously the opening can also be tightly closed, for example by using an adhesive element such as an adhesive strip.

DE 10 2007 054 714 A1 describes such a pouch-type bag comprising an adhesive element in the sealing area, so that one of the walls which overlaps the other wall at the open end of the bag is attached to the other wall after it has been folded over.

Such pouch-type bags are not suitable for mail-order business, however. One requirement in this regards is that the pouch-type bags must be securely sealed to begin with. However, it is not easy to open such pouch-type bags.

The task of the present invention is therefore to propose a generic pouch-type bag with a closure that can be easily opened.

The task is solved by a pouch-type bag according to claim 1. Further embodiments and advantageous embodiments of a pouch-type bag according to the invention are shown in claims 2 through 8 and in the following description.

A pouch-type bag according to the invention, which comprises the generic features of claim 1, is characterized in that
the sealing area between the second crease line and the adhesive element comprises a tear-off aid with which the sealing area can be at least partially severed to allow renewed access to the filling space. Of course, the tear-off aid may allow the sealing area to be completely severed, resulting in a severed portion of the sealing area and a portion of the sealing area remaining on one wall. In particular, a shipping bag is closed very tightly so that it does not open on its own during transportation due to external influences. In order for a pouch-type bag according to the invention to meet the requirements that are often demanded by mail-order companies, it is advantageous for it to have a double-layer design. In this case, at least each of the walls is composed of two layers so as to provide sufficient strength. In this advantageous embodiment, it is particularly easy to open the bag if the tear-off aid according to the invention is provided. By locating the tear-off aid between the second crease line and the adhesive element, the adhesive element and the severed portion of the sealing area can remain on the pouch-type bag and need not be removed by the user. It is advantageous if a part of the sealing area remains undamaged after the tear-off aid has been used. For this purpose, the tear-off aid may be arranged in such a way that the portion of the sealing area remaining on one wall comprises at least 20%, in particular at least 25% and preferably at least 30% of the area of the entire sealing area. In this case, it is possible to reseal the pouch-type bag. Such a resealed pouch-type bags can be used one more time to transport a filling. One example of use is the return of surplus, faulty or unsuitable goods such as items of clothing.

In an advantageous embodiment of the invention, the tear-off aid comprises a perforation line, which runs in particular parallel to the second crease line. The perforation line can thereby comprise the lateral edges of the sealing area, thus making it easier to tear open the sealing area completely. However, it is equally advantageous for the beginning and/or end of the perforation line to be spaced from the edges of the sealing area. This measure leads to a more reliable production of the pouch-type bag and will be explained in more detail later.

A perforation line comprises cuts made along a line which are interrupted by material webs. The material webs are then severed when ripping, usually along the shortest connection between two cuts. The length of the cuts may be shorter than the length of the material webs, measured along the shortest connection between the cuts. The inserted cuts can be punctiform, arched or elongated. In the case of arched or elongated cuts, these need not be parallel to the line, but may advantageously be at an angle to it. In this case, the stability of the sealing area in the area of the tear-off aid is increased without noticeably worsening the operability.

In a further advantageous embodiment of the invention, the tear-off aid comprises two substantially parallel perforation lines, which in particular run parallel to the second crease line. This embodiment simplifies tearing because the user need not move along the perforation line with an aid such as a finger or a tool, but instead tears a strip-shaped area from the sealing area based on the two perforation lines. The strip-shaped area of the sealing area is thus laterally delimited by the two perforation lines. The beginning and/or end of the strip-shaped area may be spaced from the side edges of the sealing area. Openings can be provided in the sealing area at the beginning and/or end of the strip-shaped area, which can be designed as punched-out holes, for example. These openings enable the user to better grip the strip-shaped area, thereby facilitating tearing. With regard to the design and arrangement of the perforation lines, what has been described in connection with a single perforation line applies.

In an alternative or additional embodiment of the invention, the tear-off aid may comprise at least one material strip having a greater strength than a material, in particular the paper, from which the pouch-type bag is made. This material strip can be made of plastic or of a coated paper and is arranged between the sealing area and the outer side of the wall to which the sealing area is fastened, and is fastened there in particular. Thus, tearing can also take place along a strip-shaped area. In this case, the greater strength of the material strip is important so that it does not tear off before or during the tearing process. In a combination of the material strip with one or more perforation lines, the strength of the material of the pouch-type bag is understood to be the strength when one considers the weakening of the material by the perforation. In this case, the nominal strength of the material of the pouch-type bag without a perforation line may even be greater than the strength of the material strip.

A pouch-type bag according to the invention can be further formed in that a second adhesive element is arranged between the second crease line and the tear-off aid, so as to be able to reattach a severed sealing area to the second wall. The severed sealing area can thus be equated with the portion of the sealing area remaining on one wall, which has already been described above. For a second use of the pouch-type bag, this further embodiment simplifies things for the user, since the user no longer needs a separate adhesive to attach the severed sealing area to the wall. The user can revert to the original, second crease line or define another crease line during attachment.

Furthermore, it is advantageous if the second adhesive element is covered with a removable cover element in order to be able to activate the second adhesive element only when required. In particular, the cover element prevents the sealing area from also being fastened to the outside of the other wall by means of the second adhesive element, so that the filling space is still not accessible despite being torn open.

Moreover, the tear-off aid may comprise at least one material strip having a greater strength than a material, in particular than the paper, of which the pouch-type bag is made, the material strip and the cover element being made of the same material and, in particular, being formed integrally. The same advantages described in connection with the previous embodiments are obtained. The material strip and the cover element may be provided with at least one perforation in the case of a one-piece embodiment. This perforation can be provided congruently with at least one perforation line of the sealing area. In particular, the perforation of the material and the perforation line can be created in the same step by performing the step of perforation after the step of applying the material strip and the cover element.

The first adhesive element may be covered by a second cover element, so that the first adhesive element may remain inactive until the filling space of the pouch-type bag is filled. The second cover element can be made of the same material and, in particular, be integral with the material strip and/or with the cover element that covers the second adhesive element. In this case, too, the second cover element and the material strip can be provided with a separating perforation, which in turn can advantageously be produced together with a tear-off aid designed as a perforation line.

In particular, both cover elements and the material strip can be designed in one piece and provided with at least two parallel perforation lines. These parallel perforation lines are preferably arranged directly on the perforation lines of the sealing area and are preferably congruent with them. This can be achieved in particular by generating the aforementioned perforation lines in the same work step and with the same perforation tool.

There may be advantages if the second cover element protrudes beyond at least one edge area of the envelope area. In other words, areas are provided in which the second cover element is without a support formed by the envelope area. This feature is even advantageous in the case of pouch-type bags according to the preamble of claim 1. This measure makes it easier for the user to remove the second cover element and close the pouch-type bag.

It is particularly advantageous if the second cover element protrudes beyond the edge area of the envelope area in the longitudinal direction of the pouch-type bag. As a result, the bag in its unused state is longer than a bag without this feature. In this case, it is even easier for the user to remove the second cover element.

The first cover element can also extend beyond an edge area of the envelope area.

A pouch-type bag according to the invention has a width, wherein the sealing area comprises, at least in part, a width which is smaller than the width of the bag. In this arrangement, it is advantageous if the first and/or the second cover element comprises a width, which extends in the transverse direction of the pouch, which is equal to or greater than the width of the pouch-type bag and/or the sealing area, so that the cover element is even easier to grip and remove.

Cover elements may include a release paper that is made of a base material, such as a paper or film. This base material is then soaked and/or coated with a non-stick substance. In particular, silicones, oils, greases, polypropylene and/or fluorocarbons may be used as non-stick substances. Preferably, a release paper comprising a base material of paper coated and/or soaked with a silicone. It is advantageous if the release paper has a basis weight of between 20 and 90 g/sqm, preferably between 30 and 60 g/sqm.

It is advantageous if the pouch-type bag consists of paper or mostly consists of paper (apart from adhesive elements, material strips and tear-off aids, if applicable), wherein the paper comprises a basis weight of 30 to 200 g/sqm, in particular between 50 and 150 g/sqm.

In a further embodiment of the invention, the pouch-type bag is formed from a flat web, wherein the edges of the flat web are joined together along a bonding seam extending parallel to the longitudinal direction, wherein the bonding seam is encompassed by the second wall. This embodiment is advantageous when the sealing area is associated with the first wall so that the sealing area is free of the bonding seam. If this were not the case, the tear-off aid would have to extend through the bonding seam, where there are, however, two layers of material, thus making tearing more difficult. To achieve this, it is possible to form the tube in such a way that, starting from the material web, the lateral edges are folded downwards so that the second wall with the bonding seam lies below the first wall. It is assumed that the transport direction is at least partly horizontal, meaning that the term “down” refers to the direction of gravity. Nevertheless, the bonding seam may also be encompassed by the first wall if the pouch-type bag is configured such that the second wall extends beyond the first wall at both the front end, the base end, and the rear end, the sealing end. This can be done in a conventional process by removing a piece of material from the end of the first wall. This procedure is disclosed in patent application EP 2 268 481 A1. The contents of the said patent application are deemed to be incorporated in this patent application, which means that features of EP 2 268 481 A1 can or will be referred to in the context of the present patent application.

The above-mentioned task is further solved by a method for producing a pouch-type bag, in particular a pouch-type bag according to the above description, wherein pieces of tubing are provided or a tube is separated into pieces of tubing, wherein the pieces of tubing comprise a first wall and a second wall which are connected to one another via side edges so that a filling space is provided, wherein the tube piece is transported in a transport direction, wherein, as seen in the transport direction, at the front end the second wall protrudes beyond the first wall, wherein a part of the second wall forms an envelope area, wherein a base is formed on the piece of tubing, wherein the envelope area is folded over along a crease line at least onto parts of the first wall, wherein at the rear end, as seen in the transport direction, one of the walls protrudes beyond the other wall and forms a sealing area, wherein a second crease line is provided about which the sealing area can be folded over onto the other wall, wherein an adhesive element is applied to the sealing area in order to be able to fasten the sealing area onto the other wall.

The method according to the invention is characterized by the fact that a tear-off aid is applied or inserted in or on the sealing area between the second crease line and the adhesive element, by means of which the sealing area can be at least partially severed in order to allow renewed access to the filling space.

This process achieves the same advantages that have already been described in connection with a pouch-type bag according to the invention.

In addition, the above-mentioned object is achieved by a system for producing a bag, in particular a pouch-type bag and/or for carrying out the method according to the above description, with a device for providing pieces of tubing or with a device for separating a tube into pieces of tubing, wherein the pieces of tubing comprise a first wall and a second wall, which are connected to one another via side edges so as to provide a filling space, with a transport device for transporting the pieces of tubing in a transport direction, with the second wall protruding beyond the first wall at the front end as seen in the transport direction, with a base-forming device for molding a base onto the piece of tubing, wherein an envelope area of the second wall can be folded over at least parts of the first wall along a crease line, wherein at the rear end, viewed in the transport direction, one of the walls protrudes beyond the other wall and forms a sealing area, wherein a second crease line is provided around which the sealing area can be folded onto the other wall, wherein an adhesive application device is provided with which an adhesive element can be applied to the sealing area in order to be able to fasten the closure area to the other wall.

The system according to the invention is characterized by at least one device for applying or inserting a tear-off aid in or on the sealing area between the second crease line and the adhesive element, by means of which the sealing area can be at least partially severed in order to allow renewed access to the filling space.

The same advantages are hereby achieved as have already been described in connection with the pouch-type bag according to the invention and/or the method according to the invention.

In a further embodiment of a pouch-type bag according to the invention, handle openings may be provided, wherein the handle opening extends through the second wall outside the envelope area and through the envelope area.

Consequently, the handle openings are already incorporated in the finished base, making it particularly convenient to fill the pouch-type bag via the remaining opening without the handle holes interfering with the filling process. For instance, in the exemplary use of the pouch-type bags according to the invention in the mail-order business, it is important to be able to fill them quickly. Any adverse interference should be avoided in this respect. Instead of the term “envelope area,” the term “base flap” is also used in the following.

A handle opening may be provided at various points in the pouch-type bag production process. The necessary steps for this can be carried out if a material web is available as the starting material, even before a tube is formed from the material web, from which the subsequent pouch-type bags are separated. In this case, the handle opening for a single pouch-type bag must be prepared at two different points, namely at the later envelope area and at the later second wall outside the envelope area.

Of course, the handle openings can be introduced at the later envelope area and at the second wall outside the envelope area after a tube has been separated into pieces of tubing to form the actual pouch-type bag. In particular, the separation is carried out by tearing off pieces of tubing at the front end of the tube along a previously introduced tear line, especially the perforation. After separation, there is a piece of tubing with a first wall and a second wall, which are connected to one another by side edges, the second wall protruding beyond the first wall when viewed in the longitudinal direction of the pouch-type bag. However, no base is formed yet. In this state, in turn, two openings can be made, which later, after the base is formed, lie one above the other and together form a handle opening.

However, it is also advantageous to insert a handle opening into the base only after it is completely finished.

To create handle openings, there may be at least one punch with which pieces of material can be separated and removed from the second wall outside the envelope area and/or from the envelope area. A punching knife of said punch may have a circumferential contour. Alternatively, the contour may be open such that the pieces of material remain on the base and therefore the full handle opening is not created until a user grasps the pouch-type bag through the handle opening. Such a prepared but not yet finished handle opening can also be created by a perforating knife. A handle opening perforation created in this way is advantageous in that the pieces of material are still connected to the pouch-type bag via numerous webs, so that, for example, adverse interference caused by pieces of material folding over can be avoided.

Handle opening perforations or punched-out holes can also be made without contact, in particular with the aid of a laser cutting device. The same also applies to perforations in connection with a tear-off aid.

A device for producing handle openings can be arranged in accordance with the method described above, viewed in the direction of production, between an unwinding device for unwinding a material web and a tube-forming device. Alternatively or additionally, such a device can be arranged between the tube forming device and the base folding device. It is also possible to provide the device for generating handle openings behind the base folding device, viewed in the direction of production.

The terms “first wall” and “second wall” do not imply any directional assignment. This means that the first wall in the production process can be arranged, for example, at the top or base. A pouch-type bag according to the invention comprises paper or consists entirely of paper.

In an advantageous embodiment of the pouch-type bag, the envelope area is connected to the first wall by means of a first bonding surface, wherein the envelope area is connected to a portion of the side of the second wall facing the filling space by means of a second bonding surface. In particular, this part of the side of the second wall facing the filling space is free from the first wall, i.e. not covered by the latter. Thus, it is possible for the envelope area to be connected to both the first wall and the second wall. In particular, the connection to the second wall serves to prevent a filling material located in the filling space from passing through the handle openings into the surroundings.

A bonding surface is defined by the area within which the aforementioned components, particularly the first wall, the second wall, and the envelope area, are each joined together. The bond can be brought about by applying adhesives and then bringing two components into contact with each other. An adhesive may be a cold glue, in particular a starch-based glue, a hot melt, i.e. an adhesive that can be activated by the application of heat, or double-sided adhesive labels. For the application of the adhesive, a gluing unit is provided which carries, for example on a rotatable element, a format piece corresponding to the bonding surface, which is in particular elastic. Such a format piece is often also referred to as a plate. Alternatively, a gluing unit may comprise a nozzle gluing device. This nozzle gluing device comprises several nozzles whose glue flow can be initiated or interrupted by means of valves. A row of nozzles in the transverse direction of the transport direction of the pouches is conceivable, whereby the valves are opened or closed according to the desired area when a pouch-type bag passes through.

It is further advantageous if the second bonding surface completely surrounds the handle opening. It is preferable if the bonding surface directly adjoins the edge of the handle opening. With a fully enclosed handle opening, the subsequent pouch-type bag avoids having the two layers of the handle opening formed by the second wall outside the envelope area and by the second wall move away from each other, which may result in more difficult gripping of the pouch by the user.

In an advantageous further embodiment, it is provided that the first and second bonding surfaces form a common bonding surface, wherein the envelope area of the second wall is connected to both the first wall and the second wall. In particular, if a plate is provided in the gluing unit for gluing the bonding surface, it is sufficient to provide a single plate, which reduces the complexity and/or cost.

In an advantageous embodiment of the invention, the pouch-type bag is formed from a flat web, wherein the edges of the flat web are joined together along a bonding seam extending parallel to the longitudinal direction, wherein the bonding seam is encompassed by the second wall. Accordingly, in the method according to the invention, it is provided that the bonding seam is arranged on the second wall.

This means that a flat web is folded over along at least two longitudinal edges, with the edges of the web overlapping on the second wall and being joined together there. In a system for producing a pouch-type bag according to the invention, a known tube-forming device can be provided for this purpose, which is followed by a turning station. Consequently, in such a system, the longitudinal seam can, for example, first be assigned to the upper side of the tube and, after turning, to the lower side, which then represents the second wall in the case of the individual pieces of tubing.

Instead of providing a turning station, it may be provided to perform the tube formation in such a way that the edges of the material web are folded down so that they overlap below the first wall. This alternative is suitable as a preferred solution, however, should the invention be used for an existing machine, the provision of a turning station is suitable as it can be retrofitted.

The advantage of this aforementioned procedure is that, in particular due to the action of a plate for gluing the first wall, the bonding seam is often pulled open again at the edges and corners due to adhesion to the plate, so that proper base formation is not always achieved. This circumstance is avoided by the aforementioned embodiment of the pouch-type bag.

In principle, the pouch-type bag can be formed from a piece of flat web separated from a flat web. It is also conceivable that the flat web is first processed into a tube, from which pieces of tubing are then separated.

In another advantageous embodiment of a pouch-type bag according to the invention, it is provided that a reinforcing element extending around the handle opening is arranged between the second wall and the envelope area. In this way, a handle element can be reinforced so that the pouch-type bag can be used safely even with heavier loads and the risk of the handle opening tearing is reduced. This reinforcing element, which may be in the form of a slip of paper, for example, which comprises paper in particular, is placed on the second wall and/or the envelope area and joined before the base is closed. Particularly preferably, this step is carried out before a tube is formed from a flat web, since the aforementioned areas are particularly easily accessible here. To carry out this step, an applicator can be provided, which preferably uses a roller to deposit the reinforcing elements at uniform intervals on the aforementioned areas. The applicator can comprise a separating device with which reinforcing elements can be separated from a further material web.

A method according to the invention can be further formed by providing at least one handle opening extending through the second wall outside the envelope area and through the envelope area.

This process achieves the same further advantages already described in connection with a pouch-type bag according to the invention.

In a further embodiment, a system according to the invention comprises at least one means for inserting at least one handle opening extending through the second wall outside the envelope area and through the envelope area.

The same advantages are hereby achieved as have already been described in connection with the pouch-type bag according to the invention and/or the method according to the invention.

Further advantages, features, and details of the invention will be apparent from the following description, in which different exemplary embodiments are explained in detail with reference to the figures. The respective features mentioned in the claims and in the description can be essential to the invention individually or in any combination of mentioned features. Within the scope of the entire disclosure, features and details described in connection with the pouch-type bag according to the invention naturally also apply in connection with the method according to the invention and/or with the system according to the invention, and vice versa in each case, so that with respect to the disclosure concerning the individual aspects of the invention, reference is or can always be made mutually. The individual figures show:

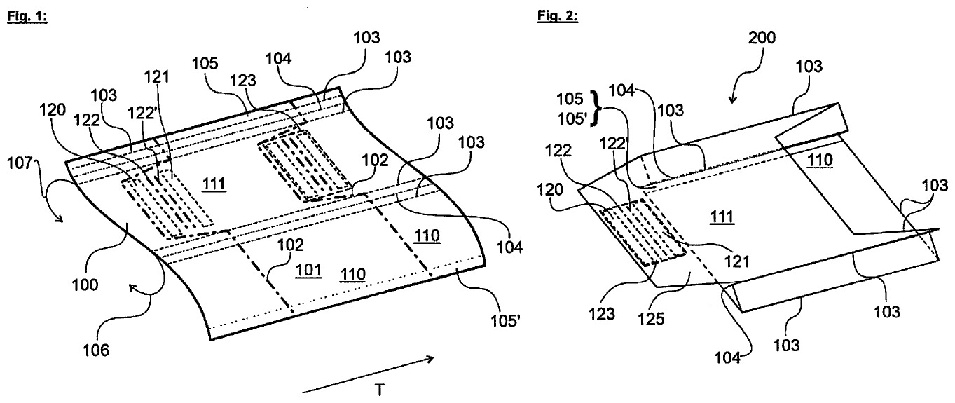

FIG. 1A material web for producing the bags according to the invention

FIG. 2A piece of tubing that was cut from the tube after the tube was formed.

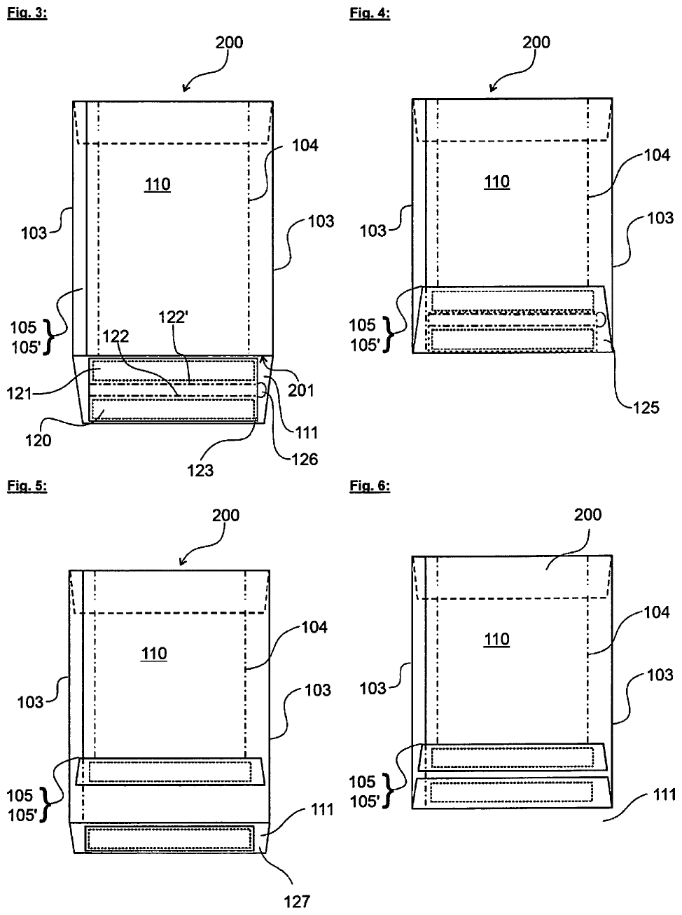

FIG. 3 Top view of a finished pouch-type bag.

FIG. 4 Top view of a finished pouch-type bag according to FIG. 3, but closed.

FIG. 5 Top view of a finished pouch-type bag as shown in FIG. 4, but which has been opened again by means of the tear-off aid.

FIG. 6 Top view of a finished pouch-type bag according to FIG. 5, which has been resealed.

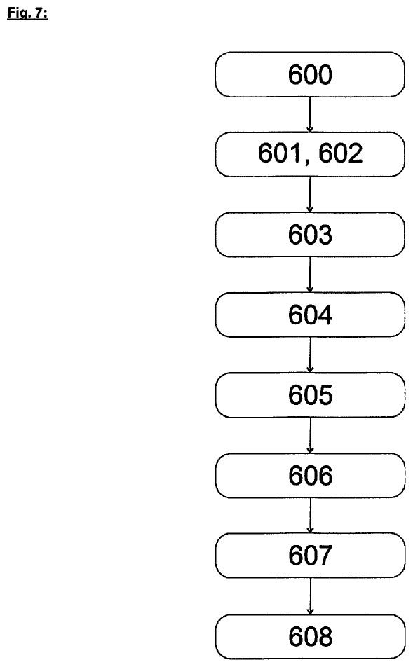

FIG. 7 Flow chart of a process for producing the pouch-type bags according to the invention.

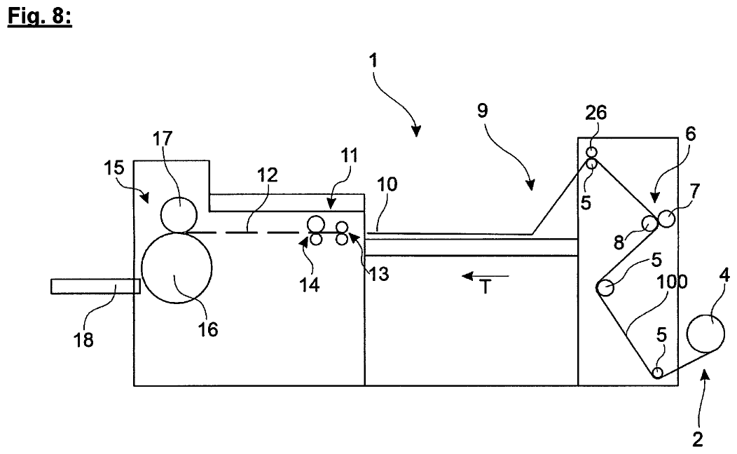

FIG. 8A device for producing the bags according to the invention

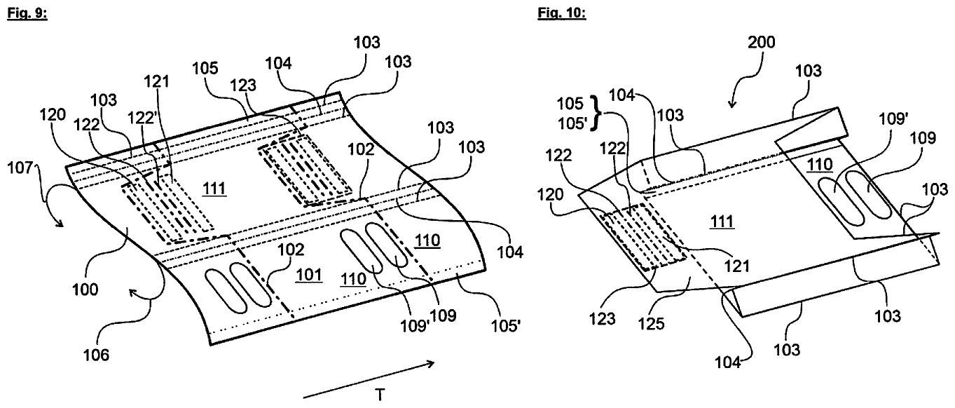

FIG. 9A material web for producing the bags according to the invention

FIG. 10A piece of tubing that was cut from the tube after the tube was formed.

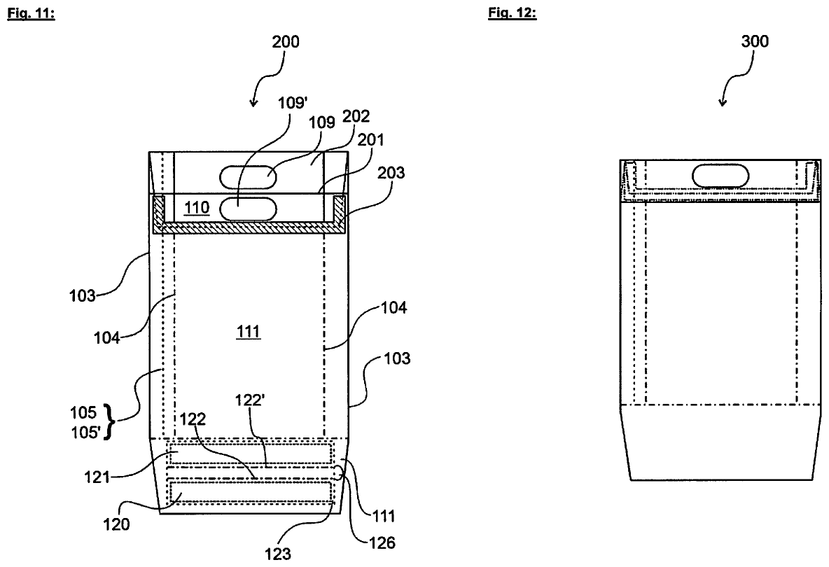

FIG. 11 Top view of the tubing section according to FIG. 10 after it has been laid flat and an adhesive surface applied

FIG. 12A pouch-type bag completed from the piece of tubing according to FIG. 11

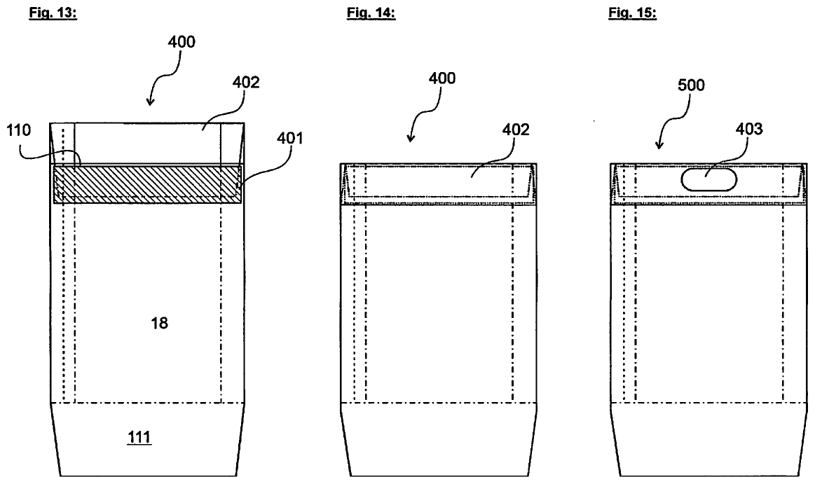

FIG. 13 Top view of the piece of tubing according to FIG. 10 after it has been laid flat and an adhesive surface has been applied, but without handle openings inserted

FIG. 14A pouch-type bag completed from the piece of tubing shown in FIG. 13, but without handle openings inserted

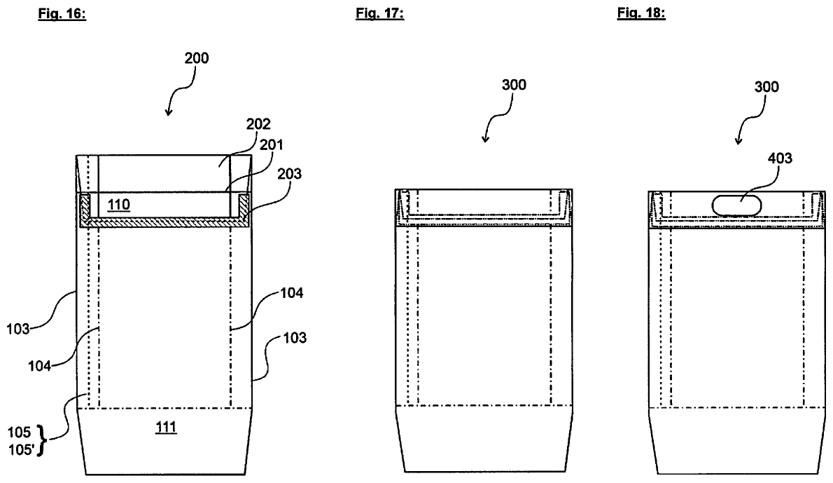

FIG. 15A finished pouch-type bag as shown in FIG. 14 with additional handle openings

FIG. 16 Top view of the piece of tubing according to FIG. 15 after it has been laid flat and an adhesive surface has been applied, but without handle openings inserted

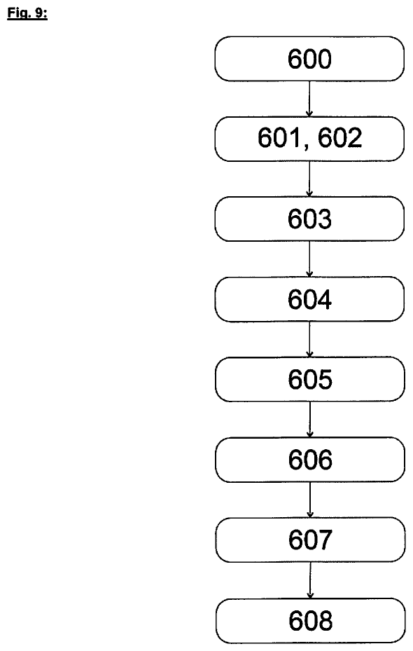

FIG. 17A pouch-type bag completed from the piece of tubing shown in FIG. 16, but without handle openings inserted

FIG. 18A finished pouch-type bag as shown in FIG. 17 with additional handle openings

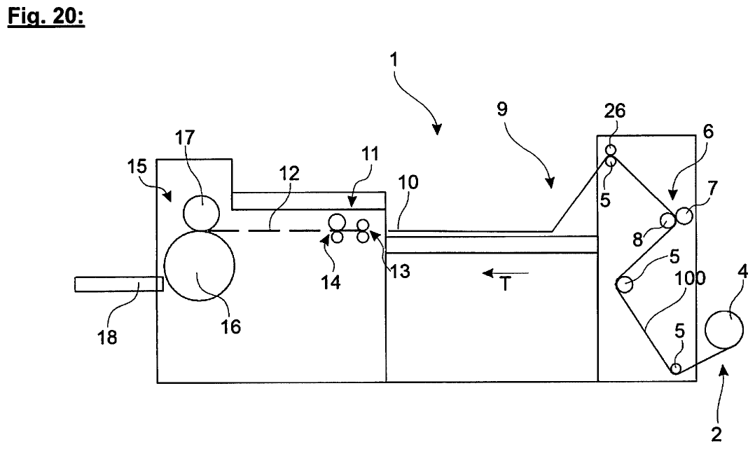

FIG. 19 Flow chart of a process for producing the pouch-type bags according to the invention.

FIG. 20A device for producing the bags according to the invention

FIG. 21A material web in a modification of the material web in FIG. 1

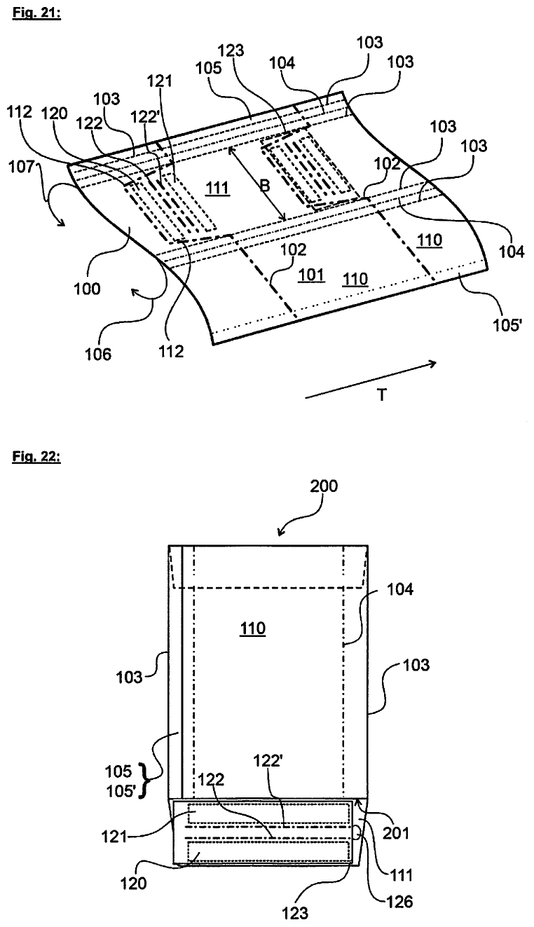

FIG. 22A modified embodiment compared to FIG. 3

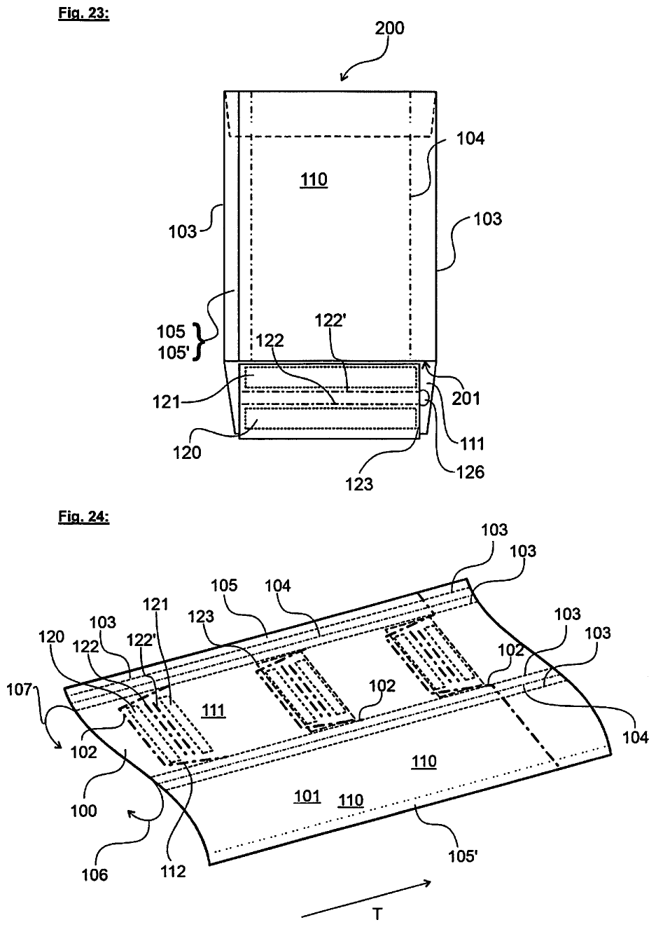

FIG. 23 Variation of a pouch-type bag

FIG. 24 Steps of a production process specifically for pouch-type bags according to FIGS. 22 and 23

FIG. 1 shows a material web 100 from which a plurality of pouch-type bags according to the invention can be produced or are produced. The web section 101, from which the tubular section necessary for the production of a pouch-type bag is produced, is characterized by thick, dash-dotted lines 102, which run partially transversely to the transport direction T of the flat web 100. The lines 102 thus represent dividing lines and may be formed by perforation. The lines 102 sometimes also have directional components in the transport direction T, which results in the two walls being staggered with respect to each other after individual pieces of tubing are later torn off, which will be explained in more detail in connection with FIG. 2. The area of the line 102 on the surface area 111 that recedes with respect to the transport direction leads to the later sealing area.

The flat web illustration is preferably a view of the outer surfaces of the later walls of the pouch-type bag. The web section 101 is divided into the surface area 110, which forms the major part of the later second wall or completely the second wall, and the surface area 111, which forms the later first wall. The surface areas 110 and 111 are bounded by the nearest interrupted lines 103 or by the lines 104. Their meaning is described below.

The interrupted lines 103 and the dash-dotted lines 104 indicate the optional gussets, with the lines 103 forming the outer edges of a gusset and the dash-dotted lines 104 forming the inner edge of a gusset. For pouch-type bags without side gussets, lines 103 are omitted and lines 104 form the outer longitudinal edges of the bag. The areas 105 and 105′ on the longitudinal edges of the flat web 100 the areas that overlap after tube formation and adhere to each other, for example by bonding.

In a preferred embodiment, at the surface area 111, in particular in the area of the recessed part of the line 102, at least two adhesive elements 120 and 121 are arranged, which are formed, for example, from hot-melt adhesive strips or from double-sided adhesive strips. These adhesive elements 120 and 121 are spaced apart from each other as seen in the transport direction T. Between these adhesive elements 120 and 121, at least one perforation 122 and at least one optional perforation 122′ are provided, which can be introduced simultaneously with the line 102, for example. However, it is also possible to insert the perforation 122 and/or the perforation 122′ before or after the line 102. FIG. 1 further shows that the adhesive elements 120 and 121 further downstream in transport direction T are covered with at least one cover element 123. This cover element 123 is also preferably provided with perforations which are in particular congruent with the perforations 122, 122′.

Even though the exemplary embodiment of FIG. 1 suggests a certain process sequence with regard to the application of the perforations, the adhesive elements and the cover element, the sequence is arbitrary. For example, it may be advantageous to first connect the adhesive elements to a cover element and then apply both to the material web 100 using an applicator. Subsequently, the perforations 122, 122′ and 102 can be inserted in one step. However, the insertion of a perforation 102 can also take place before the application of the adhesive elements and/or the cover sheet, followed by the insertion of the perforations 122, 122′.

It is advantageous if the perforations 122, 122′ have a greater strength than the perforation 102. This can be achieved, for example, by the perforations 122, 122′ being arranged at a distance from the perforation 102. Also, the ratio of the length of the web to the cut length may be greater in the perforations 122, 122′ than in the perforation 102. This embodiment is advantageous for causing a safe tear along the line 102 when separating pieces of tubing from the tubing, and for preventing a tear or tearing along the perforations 122 and/or 122′.

The curved arrows 106 and 107 now indicate that a tube is formed from the material web 100. Together with the tube formation, it is also an option to insert side gussets, since the formation of all folds running in transport direction T is efficient within a single station.

FIG. 2 now depicts a piece of tubing 200 which is torn off from the material web shown in FIG. 1 by the steps of tubing formation and separation, in which the respective front piece of tubing is torn off along the separating line 102 by applying a force in the direction T to the respective front end of the tubing and by holding the tubing behind the respective first separating line 102. The areas 105 and 105′ are arranged in an overlapping manner and are connected to each other, in particular by the use of adhesive, by a bond. Lines 103 and 104 can also be seen. Hidden lines or line areas are represented by broken or dash-dotted lines.

As can be seen, the rear area of the first wall 111, namely the sealing area 125 where the perforations 122, 122′, the adhesive elements 120, 121 and the cover element 123 are arranged, is uncovered by the second wall 110. The portion 125 of the first wall 111 protruding beyond the second wall 110 is often referred to as a closing flap or closing loop.

FIG. 3 depicts a pouch-type bag 200 that has been finished by folding at least the area of the wall 110 around a fold edge and securing it to the wall 111. The pouch-type bag is shown facing the wall 110 so that the perforations 122, 122′ and the cover sheet 123 are now visible. The adhesive elements 120 and 121 are still not visible and are shown with interrupted lines. The edge of the access opening 201 to the filling space of the pouch-type bag 200 is now visible. With reference to the exemplary embodiment of FIG. 3, an additional opening 126 is disclosed, but is not limited to this exemplary embodiment. This opening can be made, for example, by punching and/or perforating its edges so as to facilitate grasping of the tear-off aid shown in the example of perforations 122, 122′.

FIG. 4 depicts the bag 200 of FIG. 3 in a sealed condition. To achieve this condition, the user can tear off the portion of the cover element 123 covering the adhesive element 120 along the perforation 122 that also extends into the cover sheet. However, if the cover sheet is not a single piece for all the areas explained, but covers the adhesive element 120 separately, this cover sheet can simply be peeled off. The sealing area 125 is then folded over around a fold line and secured to the wall 110.

FIG. 5 depicts the pouch-type bag 200, which has been torn open. The user tears open the sealing area 125 by separating the area of material between the perforations 122, 122′ into a first portion and a second portion 127. In particular, the area of the cover element lying between these perforations 122, 122′ is also torn off. The filling space is now accessible again. The adhesive element 121, which is arranged on the second part of the sealing area, is still covered by the remaining part of the cover element.

Finally, FIG. 6 depicts the pouch-type bag 200 in a resealed condition. To do so, the cover element was removed from the adhesive element 121 and the second part 127 of the sealing area was attached to the wall 110.

FIG. 7 depicts the sequence of a preferred method for producing a bag according to the invention. In step 600, a material web 100 is first provided. In step 601, the adhesive elements 120, 121, the cover element 123 and/or the tear-off aid, designed here as perforations 122, 122′, are applied or inserted into this material web. In the optional step 602, which takes place shortly before, shortly after or simultaneously with the step 601, cross perforations are introduced into the material web, which define the subsequent perforations 102. In particular, the cross perforation and the insertion of perforations 122, 122′ may be arranged in the same station of a device us for producing pouch-type bags according to the invention. For example, it is conceivable that a cross-perforation knife for the perforations 102 and further cross-perforation knives for the perforations 122, 122′ are arranged together on a rotating element, for example a knife roller. In optional step 603, cover sheets are applied, for example by a corresponding application unit in the device. The tube is then formed in step 604, in particular with simultaneous folding of side gussets. In the following step 605, the tubing is separated into pieces of tubing. Then, in step 606, an adhesive surface is applied and, in step 607, the base is folded over and attached to the first wall of the pouch-type bag. This finalizes the pouch-type bag. If no adhesive elements, cover elements and/or tear-off aids have been applied or inserted, these can be added to the completed base in an optional step 608. This step 608 can also be carried out between steps 605 and 606.

FIG. 8 depicts a device 1 for producing pouch-type bags. In this figure, the essential components of this device are shown schematically. The device 1 comprises an unwinding device 2 to which the material web 100 is fed in the form of a reel 4. Starting from this reel 4, the material web 100 is fed via guide rollers 5 to the cross-cutting station 6 or perforating station 6. This station 6 can comprise one or more cross-cutting or cross-perforating knives, not shown in more detail, which rotate on a roller 7. Simultaneously or alternatively, perforating elements for inserting the perforations 122, 122′ may also be arranged in this station and/or likewise circulate on the roller 7. In this station 6, the material web 100 runs over a counterpressure roller 8, the main purpose of which is to provide the counterpressure required for the cutting or perforating operation. During this cutting or perforating operation, the web is not severed, but the material web 100 can be provided with weakening cuts or perforations 102, along which the tubing to be formed later tears for separation into pieces of tubing.

The material web 100 then passes through a nip formed by a further guiding roller 5 and a roller designed as a longitudinal gluing unit 26. The latter applies glue to one side area of the material web 3 so that both side areas are permanently bonded to each other after the tube formation described below.

In the following tube formation station 9, a tube 10 is formed from the material web 100 by laterally tapping the material web 100 by means of guide elements, such as guide plates, so that the edges of the material web then overlap.

The subsequently overlapping areas have already been provided with a suitable adhesive by means of longitudinal gluing unit 26. Side gussets can also be inserted during wrapping of the paper web. However, the side gussets can also be inserted after the tube has been formed. The tube 10 is now usually continued in the transport direction T.

After the tube 10 has been produced, it is separated into pieces of tubing 12 in the tear-off station 11. For this purpose, the tube 10 is fed through the nip of a first pair of rollers 13. During the further advance of the tube, it enters the nip of a second pair of rollers 14. The rollers of the second pair of rollers constantly or at least temporarily have a higher circumferential speed than the rollers of the first pair of rollers 13, the circumferential speed of which advantageously corresponds to the transport speed of the tube 10. When the next perforation seen from the leading end of the tube has passed the nip of the first pair of rollers 13, the second pair of rollers 14 engages the tube 10. This can be done by running the leading end of the tube into the nip of the second pair of rollers. However, the rollers of the second roller nip 14 can also be moved relative to the tube 10, for example perpendicularly, and can be applied against the tube. When the rolls of the second nip 14 are against the tube, the tube will tear along the cut or perforation that was made in the web at the station 6.

One of the rollers of the first pair of rollers 13 can also carry a cutting blade, with which the tube can be separated into individual pieces of tubing 101 by means of so-called smooth cuts. In this case, perforation of the flat web within station 6 can be omitted. Advantageously, in this case, the top edge of the pouch-type bag comprises a respectable rim that is not frayed or frazzled, as is the case when pieces of tubing are torn off.

The piece of tubing 200 torn from the tube now enters the base gluing and base folding station 15. For this purpose, the piece of tubing 200 is held on the base-making cylinder 16. By means of a suitable element, for example a rod, the leading end of the piece of tubing is folded over so that parts of the lower (second) wall are folded back together with parts of the upper (first) wall so that parts of the upper wall and, through the openings, also parts of the lower wall rest on the upper layer. Beforehand, the flap and/or the area of the outside of the upper wall on which the flap rests after folding back is provided with an adhesive like glue. The glue applicator, represented by the glue cylinder 17 in FIG. 12, is used for this purpose.

Once the pouch-type bag has been finalized, it is placed on a table 18 by means of the base-making cylinder 16. In this process, the pouch-type bags are usually arranged perpendicularly. The pouch-type bags can then be appropriately removed in batches from this table 18.

Application stations for applying the adhesive elements 120, 121 and/or for applying cover elements 123 and/or for applying a tear-off aid are preferably arranged upstream of the tube formation station 9 and may in particular be arranged upstream of the perforating station 6. The latter is advantageous if the tear-off aid is designed in the form of one or more perforations. However, application stations for applying the adhesive elements 120, 121 and/or for applying cover elements 123 and/or for applying or inserting a tear-off aid can also be arranged downstream of the tear-off station 11. They can be arranged upstream of the base gluing and base folding station 15. In this area, the pieces of tubing are guided by a transport device so that the elements 120, 121, 122, 122′ and 123 can be placed in the correct position.

FIG. 9 is analogous to FIG. 1 and depicts a material web 100 from which a plurality of pouch-type bags according to the invention can be produced or are produced.

In addition to the embodiment according to FIG. 1, handle openings can be made in the material web, which are designed as handle holes by way of example. In this case, two handle openings 109, 109′ are provided for each subsequent tubular section, so that these two handle openings 109, 109′ lie one above the other after the step of folding over the base flap and together form a handle opening.

The curved arrows 106 and 107 now indicate that a tube is formed from the material web 100. Together with the tube formation, it is also an option to insert side gussets, since the formation of all folds running in transport direction T is efficient within a single station.

The FIG. 10 now depicts a piece of tubing 200 according to FIG. 2. However, it can additionally be seen that the area of the second wall 110 in which the handle openings 109, 109′ are arranged is uncovered by the first wall 111. However, the first wall 111 extends beyond the second wall 110 at the rear end of the piece of tubing 200, as viewed in the transport direction T. The portion of the first wall 111 protruding beyond the second wall 110 is often also referred to as a closing flap.

The FIG. 11 now depicts the tubular section 200 in top view. The individual features already described in connection with FIGS. 1, 2. 10 and 11 are still present. The later crease line 201 around which the base flap 202 is folded over can be seen. An adhesive surface 203 has been applied to the piece of tubing in a further step, this adhesive surface 203 being applied to both the first wall and the second wall. The adhesive surface 203 has right and left angled areas and extends close to the fold edge 201. This ensures that the base flap 202 is connected both to the outside of the first wall 111 and to the inside of the second wall 110. Furthermore, it is achieved that later the area of the second wall in which the handle openings 109 and 109′ are arranged is separated from the interior of the later pouch-type bag by the bonding surface, so that access to the interior through the handle openings is prevented. In comparison with FIG. 3, in FIG. 11 there is a plan view of the wall 111 so that adhesive elements 120, 121 and cover elements 123 are not visible and are therefore shown with interrupted lines. These features are not shown in the following figures.

FIG. 12 now depicts the finished pouch-type bag 300. Compared with FIG. 11, only the base flap 202 had to be folded over around the crease line 201 onto the first wall 111 and preferably pressed. The filling material can now be introduced into the interior in the area of the closing flap. After the pouch-type bag has been closed, the closing flap being folded over onto the second wall 110 and secured there. The pouch-type bag can then be carried by a user via the handle opening.

FIG. 13 now depicts a variant of a tubular section 400 for the production of pouch-type bags according to the invention. This tubular section is similar in design to the tubular section shown in FIG. 3. Therefore, numerous features are not given and reference is made to FIG. 11 and the associated description. The differences will be discussed below. First, it is advantageous, but not mandatory, that no grip holes are provided in the material web 100. Furthermore, the adhesive surface 401 differs from the adhesive surface 203 in that its shape deviates therefrom and is preferably rectangular, so that in particular the base flap 402 is bonded, in particular glued, to the inside of the second wall and to the outside of the first wall over as large an area as possible after folding.

After performing the step of folding the base flap 402, the pouch-type bag is closed at one end, which is shown in FIG. 14.

In order to obtain a pouch-type bag 500 according to the invention, a handle opening 403 is now made in the base of the bag, the handle opening being located entirely in the area where the base flap 402 is directly connected to the inner side of the second wall 110. This situation can be seen in FIG. 15.

The handle opening can also be inserted before the base flap 402 is folded down. In the same way, the insertion of the handle opening after the folding of the base flap can be combined with the embodiments according to FIGS. 1 through 4 and the associated description. Likewise, in the embodiments described in connection with FIGS. 5 through 7, the adhesive surface can be formed analogously to that shown in FIG. 3. The sequence for producing such a pouch-type bag can be seen from FIGS. 16, 17 and 18. The reference numbers have the same meanings as described in connection with the previous FIGS. 1 through 7.

FIG. 19 depicts the sequence of a preferred method for producing a bag according to the invention. In comparison with FIG. 8, the same process steps are described identically. Process steps described in deviation from the embodiment of FIG. 8 can be combined with said embodiment.

In step 600, a material web 100 is first provided. In step 601, the handle openings 109, 109′ are made in this material web. In the optional step 602, which takes place shortly before, shortly after or simultaneously with the step 601, cross perforations are introduced into the material web, which define the subsequent separating edges 102. In particular, the cross perforation and the insertion of openings may be arranged in the same station of a device us for producing pouch-type bags according to the invention. For example, it is conceivable that a cross-perforation knife and punches for inserting the openings can be arranged together on a rotating element, for example a knife roller. In optional step 603, reinforcing sheets are applied, for example by a corresponding application unit in the device. The tube is then formed in step 604, in particular with simultaneous folding of side gussets. In the following step 605, the tubing is separated into pieces of tubing. Then, in step 606, an adhesive surface is applied and, in step 607, the base is folded over and attached to the first wall of the pouch-type bag. This finalizes the pouch-type bag. If no handle openings have been made, these handle openings can be made in the finished base in an optional step 608. This step 608 can also be carried out between steps 605 and 606.

The FIG. 20 again depicts a device 1 for producing pouch-type bags with the same elements as FIG. 8. In combination with the embodiment shown there, the station 6 can also have punching elements for inserting the handle openings 109, 109′ arranged in this station in addition to or instead of the perforating knifes and/or also circulate on the roller 7. Of course, a punching device can also be arranged in front of or behind the station 6.

FIG. 21 depicts a material web that corresponds to the material web shown in FIG. 1. Therefore, also in comparison with FIG. 1, the same elements have also been provided with the same reference numbers. In this FIG. 21, however, the sections of the perforation 102 which also run at least partially in the transport direction are marked with the reference number 112. Preferably, these sections 112 extend at an angle with respect to the transport direction T, the amount of the angle being between 0 and 30 degrees, preferably between 5 and 20 degrees. These two sections 112, as well as the section between them which runs transversely to the transport direction, preferably lie within the surface area 111 which defines a width B of the later pouch-type bag. The cover element 123 now has the particular feature that it extends in the direction of the width B beyond at least one of the sections 112, so that the latter can be gripped particularly easily. This situation is illustrated again in FIG. 22, which shows a variation of the pouch-type bag 200 illustrated in FIG. 3.

FIG. 23 depicts a further variation of a pouch-type bag 200 in which the cover element 123 protrudes beyond the lower edge of the sealing area. Viewed in the transport direction T, the cover element thus protrudes beyond the rear end of the subsequently separated tubular section. The embodiments which have been explained in connection with FIGS. 22 and 23 can of course be combined with one another.

With reference to FIG. 24, steps of a production process, in particular for the pouch-type bags according to FIGS. 22 and 23, are now explained. In a first step, at least one section 112 and/or the transverse section of the perforation line 102 lying between these sections on the surface area 111 are introduced into the web material with a first perforation device. Before, simultaneously with or after this, the adhesive elements 120, 121 and/or the perforations 122, 122′ are applied or introduced. In a subsequent step, the cover element 123 is applied and/or the perforation line 102 is completed over the entire width of the material web. The completion of the perforation line 102 is carried out with a second perforation device.

List of Reference Numbers

| | |
|---|---|
| 1 | Device for producing pouch-type bags |
| 2 | Unwinding device |
| 3 | Material web |
| 4 | Reel |
| 5 | Guide rollers |
| 6 | Cross-cutting station/perforation station |
| 7 | Roller |
| 8 | Counterpressure roller |
| 9 | Tube formation station |
| 10 | Tube |
| 11 | Tear-off station |
| 12 | Piece of tubing |
| 13 | Pair of rollers |
| 14 | Pair of rollers |
| 15 | Base gluing and base folding station |
| 16 | Base-making cylinder |
| 17 | Glue cylinder |
| 18 | Table |
| 26 | Roller designed as longitudinal gluing unit |
| 100 | Material web |
| 101 | Web section |
| 102 | Lines |
| 103 | Lines |
| 104 | Lines |
| 105 | Area |
| 105′ | |
| 106 | Curved arrow |
| 107 | Curved arrow |
| 109 | Handle opening |
| 109′ | |
| 120 | Adhesive element |
| 122 | Perforation |
| 122′ | Optional perforation |
| 123 | Cover element |
| 125 | Sealing area first portion |
| 126 | Additional opening |
| 127 | Sealing area second portion |
| 200 | Pouch-type bag |
| 201 | Access opening |
| 202 | Base flap |
| 203 | Adhesive surface |
| 300 | Pouch-type bag |
| 400 | Tubular section |
| 401 | Adhesive surface |
| 402 | Base flap |
| 403 | Handle opening |
| 500 | Pouch-type bag |
| 600 | Step |
| 601 | Step |
| 602 | Step |
| 603 | Step |
| 604 | Step |
| 605 | Step |
| 606 | Step |
| 607 | Step |
| 608 | Step |
| T | Transport direction |

1. A pouch-type bag,
with a first wall and a second wall which comprise paper and which are joined together by side edges so as to provide a filling space, the second wall protruding beyond the first wall as viewed in the longitudinal direction of the bag,
with two ends, wherein a base is arranged at one end, which base comprises at least one envelope area of the second wall, wherein the envelope area is folded over about a first crease line at least onto parts of the first wall, wherein an opening is provided at the other end, via which opening the filling space is accessible, wherein one of the walls comprises a sealing area which can be folded over about a second crease line onto the outside of the other wall and can be fastened there by means of an adhesive element applied to the sealing area,
characterized in that
the sealing area between the second crease line and the adhesive element comprises a tear-off aid with which the sealing area can be at least partially severed to allow renewed access to the filling space.

2. Pouch-type bag according to claim 1
characterized in that
the tear-off aid comprises a perforation line, which runs in particular parallel to the second crease line.

3. Pouch-type bag according to claim 1
characterized in that
the tear-off aid comprises two substantially parallel perforation lines, which in particular run parallel to the second crease line.

4. Pouch-type bag according to claim 1
characterized in that
the tear-off aid may comprise at least one material strip having a greater strength than a material, in particular the paper, from which the pouch-type bag is made.

5. Pouch-type bag according to claim 1
characterized in that
a second adhesive element is arranged between the second crease line and the tear-off aid, so as to be able to reattach a severed sealing area to the second wall.

6. Pouch-type bag according to claim 5
characterized in that
the second adhesive element is covered with a removable cover element in order to be able to activate the second adhesive element only when required.

7. Pouch-type bag according to claim 1
characterized in that
the tear-off aid comprises at least one material strip having a greater strength than a material, in particular than the paper, of which the pouch-type bag is made, the material strip and the cover element being made of the same material and, in particular, being formed integrally.

8. Pouch-type bag according to claim 1
characterized in that
the pouch-type bag is formed from a flat web, wherein the edges of the flat web are joined together along a bonding seam extending parallel to the longitudinal direction, wherein the bonding seam is encompassed by the second wall.

9. A method for producing a pouch-type bag, in particular a pouch-type bag according to claim 1, wherein pieces of tubing are provided or a tube is separated into pieces of tubing, wherein the pieces of tubing comprise a first wall and a second wall which are connected to one another via side edges so that a filling space is provided, wherein the tube piece is transported in a transport direction, wherein, as seen in the transport direction, at the front end the second wall protrudes beyond the first wall, wherein a part of the second wall forms an envelope area, wherein a base is formed on the piece of tubing, wherein the envelope area is folded over along a crease line at least onto parts of the first wall, wherein at the rear end, as seen in the transport direction, one of the walls protrudes beyond the other wall and forms a sealing area, wherein a second crease line is provided about which the sealing area can be folded over onto the other wall, wherein an adhesive element is applied to the sealing area in order to be able to fasten the sealing area onto the other wall.
characterized in that
in or on the sealing area between the second crease line and the adhesive element, a tear-off aid is applied or inserted with which the sealing area can be at least partially severed to allow renewed access to the filling space.

10. Method according to claim 9
characterized in that
the tear-off aid is inserted into the sealing area as a perforation line, in particular with a perforation tool.

11. Method according to claim 9
characterized in that
a material strip which comprises a greater strength than a material, in particular the paper, from which the pouch-type bag is made, is applied to the sealing area by means of an application device as a tear-off aid.

12. A system for producing a bag, in particular a pouch-type bag according to claim 1, with a device for providing pieces of tubing or with a device for separating a tube into pieces of tubing, wherein the pieces of tubing comprise a first wall and a second wall, which are connected to one another via side edges so as to provide a filling space, with a transport device for transporting the pieces of tubing in a transport direction, with the second wall protruding beyond the first wall at the front end as seen in the transport direction, with a base-forming device for molding a base onto the piece of tubing, wherein an envelope area of the second wall can be folded over at least parts of the first wall along a crease line, wherein at the rear end, viewed in the transport direction, one of the walls protrudes beyond the other wall and forms a sealing area, wherein a second crease line is provided around which the sealing area can be folded onto the other wall, wherein an adhesive application device is provided with which an adhesive element can be applied to the sealing area in order to be able to fasten the closure area to the other wall,
characterized in that
at least one device for applying or inserting a tear-off aid in or on the sealing area between the second crease line and the adhesive element, by means of which the sealing area can be at least partially severed in order to allow renewed access to the filling space.

13. A system for producing a bag, in particular a pouch-type bag for carrying out the method according to claim 9, with a device for providing pieces of tubing or with a device for separating a tube into pieces of tubing, wherein the pieces of tubing comprise a first wall and a second wall, which are connected to one another via side edges so as to provide a filling space, with a transport device for transporting the pieces of tubing in a transport direction, with the second wall protruding beyond the first wall at the front end as seen in the transport direction, with a base-forming device for molding a base onto the piece of tubing, wherein an envelope area of the second wall can be folded over at least parts of the first wall along a crease line, wherein at the rear end, viewed in the transport direction, one of the walls protrudes beyond the other wall and forms a sealing area, wherein a second crease line is provided around which the sealing area can be folded onto the other wall, wherein an adhesive application device is provided with which an adhesive element can be applied to the sealing area in order to be able to fasten the closure area to the other wall,
characterized in that
at least one device for applying or inserting a tear-off aid in or on the sealing area between the second crease line and the adhesive element, by means of which the sealing area can be at least partially severed in order to allow renewed access to the filling space.
